(19) United States
(12) Patent Application Publication
(10) Pub. No.: US 2010/0136162 A1
(43) Pub. Date: Jun. 3, 2010

(54) DENTAL DIET FOR REDUCING TARTAR

(75) Inventors: Carolyn Jean Cupp, Libery, MO (US); Lynn Ann Gerheart, Smithville, MO (US); Scott Schnell, St. Joseph, MO (US); Sheri Lynn Smithey, St. Joseph, MO (US); Donna Elizabeth Anderson, Weatherby Lake, MO (US)

Correspondence Address: K&L Gates LLP, P.O. Box 1135, CHICAGO, IL, 60690, US

(73) Assignee: NESTEC LTD., Vevey (CH)

(21) Appl. No.: 12/610,829

(22) Filed: Nov. 2, 2009

Related U.S. Application Data
(63) Continuation of application No. 10/037,941, filed on Jan. 3, 2002, now abandoned.
Application No. 10/037,941 is a continuation-in-part of application No. 09/483,328, filed on Jan. 14, 2000, now abandoned.
Application No. 09/483,328 is a continuation-in-part of application No. 09/154,646, filed on Sep. 17, 1998, now abandoned.

(51) Int. Cl. A23K 1/20; A23J 1/00; A23L 1/05; A23P 1/12

(52) U.S. Cl. 426/2; 426/656; 426/573; 426/516

(57) ABSTRACT

A dried pet food which is able to mechanically clean the teeth of pets when chewed. The pet food is based on a matrix of a protein source and a carbohydrate source. The density of the product is less than 20.5 lbs/ft³. The product also has a large size as compared to at least some other prior dried pet food.

### CROSS REFERENCE TO RELATED APPLICATIONS

This application is a continuation of U.S. patent application Ser. No. 10/037,941, filed Jan. 3, 2002, which is a Continuation-in-Part of U.S. patent application Ser. No. 09/483,328, filed Jan. 14, 2000, now abandoned, which is a Continuation-in-Part of U.S. patent application Ser. No. 09/154,646, filed Sep. 17, 1998, now abandoned, the contents of which are expressly incorporated herein by reference thereto.

### BACKGROUND

The present invention relates generally to pet foods. More specifically, the present invention relates to pet foods that when chewed by pets, cause a mechanical, abrasive cleaning of the pets' teeth.

Many pets suffer from dental health problems. It is estimated that over 70% of dogs have some degree of gingival or periodontal disease. Plaque formation on the surface of the pets' teeth is a primary factor in the development of such problems. Dental plaque is a combination of bacteria, bacterial by-products which form a glycoprotein matrix, and salivary percipates which bind to the tooth surface.

Contributing to the problem is the formation of tartar or dental calculus (mineralized plaque). Dental calculus forms on the tooth surface at or above the gum line and serves as a substrate for the additional accumulation of plaque. Apart from causing gum irritation and potentially, periodontal disease if left untreated, this calculus has an unsightly appearance.

Pets are more susceptible to the formation of plaque and calculus than animals in the wild. This is due to the nature of the foods that pets eat. In the wild, many animals eat foods that mechanically abrade plaque and calculus from the teeth. In contrast, pets are usually fed commercially available pet foods that although they may provide better nutritional value, do not in general subject the teeth to abrasive forces sufficient to clean the teeth. This is even true of dried kibbles that are able to abrade the teeth only to a very limited extent. In part, this is due to the fact that dried kibbles usually crumble when chewed by the pet.

Maintenance of optimal dental health depends on regular professional cleaning of all these accumulations both above and below the gum line, as well as adequate home care. Mechanical cleansing of the tooth surfaces with tooth brushing is an effective means of controlling the buildup of plaque and calculus in both humans and pets. However, most pet owners are reluctant or unable to provide the routine brushing necessary to maintain good oral health in their pets and would likely welcome an alternative provided by dietary means.

There have been various attempts to provide products for improving pet dental health. One such attempt centers around the use of chews made from rawhide or rawhide substitutes. By allowing the pet to gnaw or chew on such rawhide products, the pet abrades calculus and plaque from its teeth. It is also possible, as described in European patent application 0272968, to incorporate various oral care agents into such chews. These products, however, have the drawback that they are typically expensive. Moreover, they are usually only effective with dogs that are prone to chew and gnaw.

Another approach has been to incorporate oral care agents into certain pet foods. For example, U.S. Pat. No. 5,000,940 discloses baked dog biscuits which contain a tetrasodium pyrophosphate salt. The patent states that the salt causes a reduction in calculus accumulation. Another example of such an approach is, European patent application 0205354 which discloses baked dog biscuits which contain vegetable fibers to abrade the teeth of the dog when chewed. A drawback with both of these products, however, is that the biscuits crumble upon being bitten. Hence, the dog cannot chew the product and little abrasion occurs. This thereby reduces the efficacy of the product. A further approach is described in U.S. Pat. No. 5,431,927. That patent describes a dried product which contains aligned fibers which, when chewed, fracture in long striations rather than crumbling. The patent states that this allows the product to remain in contact with the animals' teeth for a longer period of time hence enhancing the abrasive effect. However, a disadvantage of this product is that it must be produced using a specially coated die that allows laminar flow conditions within the die. The laminar flow condition is reported to cause the alignment of the fibers within the product leading to the fracturing of the product when bitten by the animal. The use of such dies necessitates a complicated procedure for manufacturing the product.

There is therefore a need for an improved dental care pet food.

### SUMMARY

The present invention provides a dry pet food that will reduce tartar when chewed by the pet. It has been surprisingly found that by reducing the density and/or increasing the size of the pet food product, that the resultant product will remove more plaque and tartar build-up than similar pet food products.

To this end, in an embodiment the present invention provides a dried pet food comprising a matrix including a protein source, a carbohydrate source, an insoluble fiber, and having a density of less than 20.5 lbs/ft³.

In a further embodiment of the present invention, a dried pet food is provided comprising a matrix including a protein source, a carbohydrate source, insoluble fiber and having a length of at least 15 mm, a width of at least 13.5 mm, and a thickness of at least 12 mm.

In a still further embodiment of the present invention, a dried pet food is provided comprising a matrix including a protein source, a carbohydrate source, insoluble fiber, a density of less than 20.5 lbs/ft³, and dimensioned so as to have a length of at least 15 mm, a width of at least 13.5 mm, and a thickness of at least 12 mm.

In yet another embodiment of the present invention, a dried pet food is provided comprising at least 25% by weight of a kibble including a matrix having a protein source, carbohydrate source, insoluble fiber, and a density of less than 20.5 lbs/ft³.

In an embodiment of any of the above inventions, the protein source comprises denatured protein.

In an embodiment of any of the above inventions, the carbohydrate source comprises gelatinized carbohydrate.

In an embodiment of any of the above inventions, the insoluble fiber comprises approximately 2% to about 15% by weight of the matrix.

In an embodiment of any of the above inventions, the insoluble fiber may be a cellulose fiber.

In an embodiment of any of the above inventions, the product may include a humectant.

Methods of reducing calculus and plaque on pets' teeth are also provided. To this end, in an embodiment, a method of reducing calculus and plaque build-up on a pet's teeth is provided comprising the step of allowing the pet to chew on dried pet food having a matrix including a protein source, a carbohydrate source, insoluble fiber, and having a density of less than 20.5 lb/ft³.

An advantage of the present invention is to provide an improved pet food for reducing tartar on pets' teeth.

Another advantage of the present invention is to provide an improved dental care pet food for dogs.

A still further advantage of the present invention is to provide an improved dental care product that can be mixed with regular pet food and still achieve dental health care benefits for the pet.

Moreover, an advantage of the present invention is to provide a dried pet food that does not require the use of a humectant.

Furthermore, an advantage of the present invention is to provide an improved method for making dried pet food that provides dental benefits.

Further, an advantage of the present invention is to provide a cost effective method for improving the dental health of pets.

Additional features and advantages of the present invention are described in and will be apparent from the detailed description of the presently preferred embodiments set forth below.

### DETAILED DESCRIPTION

The present invention relates generally to dried pet food for cleaning pets' teeth. It has been surprisingly found that by reducing the density of dried pet food and/or providing a larger product, that an improved tartar removing product can be provided for pets. This is true even if the product does not include a texturizing agent (humectant).

In a preferred embodiment, the present invention provides a dried pet food comprising a matrix including a denatured protein source, a gelatinized carbohydrate source, and insoluble fiber. Preferably, the pet food has a density of approximately 10 lb/ft³ (250 kg/m³) to about 20.5 lb/ft³ (330 kg/m³), in an embodiment, approximately 16.8 lb/ft³ (270 kg/m³) to 20 lb/ft³ (320 kg/m³). Furthermore, preferably the pet food is dimensional such that it has a length of at least 15 mm, a width of at least 13.5 mm, and a thickness of at least 12 mm. In an embodiment, the pet food has a length of approximately 20 mm, a width of at least 15 mm, and a thickness of at least 18 mm.

The product may be provided in kibble shapes such as triangles, pentagons and stars. An example of a triangle shape kibble has the following dimensions: thickness 16 mm, base 28 mm and sides 32 mm. An example of a pentagon shape kibble has a diameter of 22.8 mm and a thickness of 14.2 mm.

It should also be noted that the product can be provided so that in the same serving or package the pet will receive kibbles of different sizes. For example, the pet could receive both large and small kibbles. For example, a blend of large to small kibbles within the range of 80 to 20% to 20 to 80% based on number could be provided. In a preferred embodiment, the large kibbles comprise approximately 20 to about 50% by number.

Preferably, the pet food has a texture such that a probe, having a contact area of about 1 mm² and operated at a speed of about 5 mm/s, penetrates into the matrix for a distance of at least about 30% of the thickness of the matrix prior to breaking the matrix, more preferably at least about 40%. For example, for a dog food, the probe may penetrate a distance of approximately 6.0 mm, preferably at least 6.5 mm, prior to breaking the matrix.

The carbohydrate source is conveniently a grain such as corn, rice, wheat, beets, barley, oats, or soy, and/or mixtures of these grains. The grain is typically provided in the form of a flour or a meal. Pure or substantially pure starches may also be used if desired. The exact carbohydrate source or sources used in the present invention is not critical to the invention. Generally, the carbohydrate source is selected on the basis of cost and palatability. It should be noted that the carbohydrate source may or may not contain protein. In a preferred embodiment, the dried pet food contains approximately 20% to about 65% by weight of carbohydrate.

A variety of protein sources can be used for the protein component. The protein source may be a vegetable protein source, an animal protein source, or a mixture of these protein sources. Suitable vegetable protein sources include gluten, wheat protein, soy protein, rice protein, corn protein, and the like. These proteins can be provided in the form of flours, concentrates, and isolates, as desired. Suitable animal protein sources include muscular or skeletal meat of mammals, poultry, and fish; meals such as meat meal, bone meal, fish meal, and poultry meal; by-products such as hearts, liver, kidneys, tongue, and the like; and milk proteins. Preferably, the dried pet food contains approximately 12% to about 50% by weight proteins, and in a most preferred embodiment, more than about 25% by weight protein.

The insoluble fiber may be any suitable fiber. By way of example, suitable fibers include soy fiber, rice hull fiber, pea hull fiber, oat hull fiber, barley hull fiber, sugarbeet fiber, wheat bran fiber, and pure cellulose. One such cellulose fiber is Solka-Floc®. Generally, the fiber is selected on the basis of cost and palatability considerations. However, as noted above, the product should have a density less than 20.5 lb/ft³. Accordingly, a fiber must be selected which results in a lower density product. Accordingly, a cellulose fiber may be used in a preferred embodiment. If used, preferably, the dried pet food contains approximately 2% to about 15% by weight of insoluble fiber.

As noted above, a texturizing agent is not necessary. However, if a texturizing agent is desired, a humectant may be provided. The humectant may be any suitable humectant, for example, glycerin, propolyne glycol, butylene glycol, polyhydric glycols such as glycerol and sorbitol, hydrogenated starch, hydrolysates and the like. If used, the dried pet food can contain up to 5% by weight humectant. However, in an embodiment, the product does not include a humectant.

If desired, abrasive agents may also be included. Suitable abrasive agents include ground oyster shells, titanium dioxide, and the like. Similarly dental care agents may also be used if desired; for example, pyrophosphate salts such as tetrasodium pyrophosphate.

Various other ingredients, for example, salt, spices, seasonings, vitamins, minerals, flavoring agents, lipids, and the like may also be incorporated into the dried pet product as desired. If added, the lipids may be any suitable animal fat; for example tallow, or may be a vegetable fat.

The dried pet food may be manufactured in many different ways as desired. However extrusion gelatinization is found to be particularly suitable.

In a specific example of a suitable extrusion gelatinization process, a dry feed mixture is prepared from a protein source, a carbohydrate source, insoluble fiber, vitamins, and minerals. The dry feed mixture is then fed into a preconditioner.

In the preconditioner, water or steam, or both, is mixed into the dry feed mixture. Further, liquid flavor components, such as flavor digests or tallow, may be mixed into the dry feed mix in the preconditioner. Sufficient water, steam, or liquid flavor components is mixed into the feed mixture to raise the moisture content of the dry feed mixture to approximately 10% to about 30% by weight. If desired, the temperature of the dry feed mixture may be raised in the preconditioner to approximately 60° C. to about 95° C. A suitable preconditioner is described in U.S. Pat. No. 4,752,139.

The moistened feed leaving the preconditioner is then fed into an extruder. If the product will include a humectant, the humectant is conveniently added to the moistened feed in the extruder. The extruder may be any suitable single or twin screw, cooking-extruder. Suitable extruders may be obtained from Wenger Manufacturing Inc., Clextral S A, Bühler A G, and the like. During passage through the extruder, the moistened feed passes through a cooking zone, in which it is subjected to mechanical shear and is heated to a maximum temperature of up to about 130° C., and a forming zone. The gauge pressure in the forming zone is approximately 600 kPa to about 10 Mpa as desired. If desired, water or steam, or both, may be introduced into the cooking zone. Further, during passage through the extruder, the starch ingredients of the moistened feed are gelatinized to provide a gelatinized matrix of starch, protein, insoluble fiber, and humectant.

The gelatinized matrix leaving the extruder is forced through a die. Any suitable die may be used. However, the orifice of the die is preferably chosen such that the distance from the center of the orifice to any inner surface is at least about 5 mm. This ensures that the extrudate has a diameter of at least about 18 mm; more preferably at least about 20 mm. Further, the orifice is preferably substantially circular or substantially elliptical in cross-section. This provides an extrudate which is substantially circular or substantially elliptical in cross-section. This has the advantage that the end product does not have portions of reduced thickness which are easier for the animal to break when chewing.

Upon leaving the die, the extrudate is cut into pieces using blades. The blades are preferably arranged such that the pieces have a length of at least about 12 mm; for example about 14 mm. The individual pieces may then be processed as desired. For example, they may be partially or fully dried and coated with further flavoring agents. After cooling, the pieces may be packed into suitable packages.

After drying, the pieces preferably have a moisture content of less than about 10% by weight; for example about 3% to about 7% by weight when leaving the drier. The pieces preferably have a water activity of less than about 0.7; more preferably less than about 0.6.

It should be noted that the product is not formulated through a laminar flow extrusion process. Rather, the product is formulated in an extrusion process that is more turbulent in nature.

This results, in part, in a product that is not striated. Thus, the resultant product does not have visible striations. As used herein, the term “unstriated” means substantially without visible striations. The product of the present invention is preferably unstriated.

The product also has a cellular structure, with microscopic air pockets. Preferably, the interior of the product has a large number of microscopic air pockets. This cellular structure is apparent when the product is broken apart and the inner surface is examined. The inner surface will have a fine sandpaper-like appearance. Thus, the interior of the structure has a dense foam-like structure. This should be contrasted with a laminar-like structure. This cellular structure improves the tartar reducing properties of the product. In this regard, the cellular structure provides or applies a mechanical scraping action to the teeth. Being of a low density, the foam absorbs tooth pressure without splintering and/or crumbing during the chewing process.

The inventors believe that the structure of the pet food product of the present invention is different than pet food products of the prior art. The product pores of the present invention have a generally blocky rounded dimension.

In contrast, in striated prior art structures, such as those disclosed in EP 0575021A2, the pet food product has longitudinal pores having relatively thick walls with a presence of large solid area between the stretched wall structure of the pores. In contrast, in the products of the present invention, the interior has wider and more circular (spheric) pores, relatively thinner walls, and a sponge-like structure with a more regular cutting edge (not stretched). The prior art striated product presents a less homogeneous pore shape and distribution as compared to the present invention which have a more regular pore distribution and shape. The differences in internal structure is due to the process that is used to manufacture each respective pellet: more mechanical shear for the prior art pellets (stretched, more laminar structure); and more expansion for the present invention pellets.

The above differences were determined from microscopic observations made of the cut pellets. To this end, cut sides of pellets were examined with an Olympus CH2 microscope having a magnification of 10. To evaluate the cut pellets, a table stand illuminator allowed observations under the microscope with a lighting above the sample (incident light) since the light equipment of the microscope allows an illumination by transmission.

In addition, acoustic analyses were performed on the present invention pellets and prior art using differences in sound profiles obtained when each product is penetrated with a probe that carries a micro-microphone. It was found that the prior art pellets produced higher intensity in the high frequency range while the present invention pellets produced higher intensity in the low frequency range. This indicates that the mechanical characteristics of the materials which constitute the two pellets are different. It is believed that the lamellar and torn structure of the prior art pellets may produce higher frequency vibration when broken than the more agglomerated and homogeneous structure of the pellets of the present invention which are better able to vibrate at lower frequency. It is believed that the intensity and frequency of the walls vibration during breaking (bitting, mastication) may have a positive impact on the tooth cleaning effect. The structure, rheological, mechanical and acoustic properties and physico-chemical characteristics of the prior art and present invention pellets are clearly different and should present different functionalities in terms of dental plaque and tartar reduction.

By way of example, and not limitation, examples of the present invention will now be given.

### Example No. 1

A dry mix is prepared from about 63% by weight of whole corn, about 16% by weight of beef and bone meal, about 14% soybean meal, about 4% by weight of fish and poultry meals, and about 3% by weight of cellulose and various vitamins and minerals. The dry mix is fed into a preconditioner along with a flavor digest. The preconditioned mixture is then fed into an extruder with or without about 2% by weight of glycerin. The preconditioner is operated at about 87° C. Steam is injected into the preconditioner at about 9% DMR and water at about 4% DMR.

The moistened feed leaving the preconditioner is then fed into a model 165 extruder obtained from Wenger and gelatinized. The extruder has six zones and the temperatures in the six zones are about 87° C., about 87° C., about 102° C., about 101° C., about 102° C., and about 127° C. The pressure upon leaving the extruder is about 3.4 MPa gauge.

The gelatinized mixture is forced through the orifice of a die. The orifice is in the shape of a circle in cross section with a diameter of 10 mm. The extrudate leaving the die is cut into pieces of 14 mm length. The pieces are then coated with flavoring agents and dried in the normal manner.

The pieces have a density of about 328 kg/m³ and a moisture content of about 8.5% by weight.

### Example No. 2

An amount of 50 dried pieces obtained using the process of Example 1 are subjected to texture analysis using a TA-XT2 Texture Analyzer obtained from Stable Micro Systems, Inc. The Texture Analyzer is fitted with a rod-like probe which has a length of about 52 mm. The probe is made up of two sections; a first section and a second section. The first section has a length of about 21 mm and a constant diameter of about 9.5 mm. The second section tapers down to a point having a contact area of about 1 mm². The Texture Analyzer is operated at a speed of 5 mm/s and a contact force of 5 g.

Each piece is placed on a base under the probe. The probe is moved downwardly and into the piece. The distance of penetration of the probe into the piece, the compression force and the time are recorded at a rate of 200 recordings per second. Breakage of the piece is determined upon a sharp fall off of the compression force. The distance of penetration, the compression force and the time are recorded at the moment of breakage. The values obtained for all pieces are then averaged.

For comparison, the process is repeated for each group of 50 pieces of products used in the dental trial (Example 3). The results are as follows:

| Product | Distance to breakage/mm |
|---|---|
| Example 1 -- Test Diet 1 | 6.56 |
| Example 1 -- Test Diet 2 | 9.50 |
| Purina Dog Chow | 3.30 |

The results indicate that the pieces of Example No. 1 are significantly better than standard dry dog foods.

Because the product of Example 1 is resistant to breakage, the animal needs to bite deeper into each piece of the product before it breaks. Therefore the animal's teeth are subjected to improved mechanical cleaning.

### Example No. 3

A group of 36 healthy adult dogs are used in this trial. Each animal is given a complete veterinary physical examination. Oral exams are also conducted to select only dogs without obvious dental/oral problems. The dogs are divided into three groups of 12 dogs each with an even distribution of age, sex, and susceptibility to calculus formation in each group. During the trial, the dogs have ad libitum access to water and food and are fed once daily. The food consumption of each dog is monitored daily. The weight of each dog is recorded at the start of the trial and again each week.

The trial is initiated by performing complete dental prophylaxis on all dogs to carefully remove (by ultrasonic teeth cleaning) all supra- and sub-gingival deposits of plaque and calculus. Also, the dogs' teeth are thoroughly polished. Each group of dogs is then randomly allocated a different food product and fed that product for the duration of the trial. Group 1 is fed the pieces of Example No. 1, test diet 1; Group 2 is fed the second dental prototype of Example No. 1, test diet 2; and Group 3 is fed Purina Dog Chow.

After 7 days of feeding, dogs are sedated and a few drops of a 3% erythrosin plaque-disclosing solution are applied to the teeth of each dog and then thoroughly rinsed off with tap water. Plaque evaluation is then carried out on gingival and occlusal halves of the upper third incisors, upper and lower canines, upper 3^{rd} and 4^{th} premolars, upper first molars, lower 3^{rd} and 4^{th} premolars, and lower first molars. An assessment of the buccal tooth surface that is covered with plaque is made according to the following scale:

0=No observable plaque;

1=Plaque covering less than 25% of the tooth surface;

2=Plaque covering between 25% and 50% of the tooth surface;

3=Plaque covering between 50% and 75% of the tooth surface;

4=Plaque covering greater than 75% of the tooth surface.

Plaque thickness is assessed as follows:

1=Light or thin, a light pink color;

2=Medium, a moderate or medium shade of red;

3=Heavy or thick, a dark bright shade of red.

A score is then obtained by multiplying the coverage score by the thickness score for each half of the 14 teeth to give a score ranging from 0 to 12. The score for each half of a tooth are added to provide a whole tooth score. The whole tooth scores are then averaged.

On the 21^{st} day of the trial, evaluation of calculus is similarly performed for each animal on the proximal, mesial, and distal thirds of the 18 teeth previously examined. No disclosing solution is used to score calculus. The scores for each third of a tooth are added to provide a whole tooth score and all whole tooth scores are averaged. Concurrent with calculus scoring, a gingival index is performed in which one score is recorded per tooth based on the most severe portion of the tooth's gingival margin. Gingival index is assessed as follows:

0=No inflammation or swelling;

1=Mild inflammation, slight redness or swelling, no bleeding on gentle probing;

2=Moderate inflammation, redness and swelling, bleeding on gentle probing;

3=Severe inflammation, bright red and swollen gingiva, spontaneous bleeding on probing.

Scores for all animals in each group are averaged and the results are as follows:

| | Plaque Score | Calculus Score | Gingival Index |
|---|---|---|---|
| Product | Day 7 | Day 21 | Day 21 |
| Example 1 Dental | 6.45 | 3.87 | 0.24 |
| Test 1 | | | |
| Example 1 Dental | 6.93 | 4.06 | 0.24 |
| Test 2 | | | |
| Purina Dog Chow | 7.79 | 5.33 | 0.46 |

The results indicate that the products of Example No. 1 show significantly improved cleaning of the dogs' teeth over a commercially available dry dog food. These results correlate with those of Example No. 2.

### Example No. 4

A group of 36 healthy adult dogs are used in this trial. Each animal is given a complete veterinary physical examination. Oral exams are also conducted to select only dogs without obvious dental/oral problems. The dogs are divided into three groups of 12 dogs each with an even distribution of age, sex, and susceptibility to calculus formation in each group. During the trial, the dogs have ad libitum access to water and food and are fed once daily. The food consumption of each dog is monitored daily. The weight of each dog is recorded at the start of the trial and again each week.

The trial is initiated by performing complete dental prophylaxis on all dogs to carefully remove (by ultrasonic teeth cleaning) all supra- and sub-gingival deposits of plaque and calculus. Also, the dogs' teeth are thoroughly polished. Each group of dogs is then randomly allocated a different food product and fed that product for the duration of the trial. Group 1 is fed the pieces of Example No. 1, test diet 1, in a 50:50 blend with standard-sized Alpo Complete pieces. Group 2 is fed the pieces of Example No. 1, test diet 1, in a 25:75 blend with standard-sized Alpo Complete pieces (25% dental pieces). Group 3 is fed standard Alpo Complete dry dog food.

Plaque, calculus, and gingival scores are performed as in Example No. 3. Scores for all animals in each group are averaged and the results are as follows:

| | Plaque Score | Calculus Score | Gingival Index |
|---|---|---|---|
| Product | Day 7 | Day 21 | Day 21 |
| 50% Dental | 7.69 | 3.29 | 0.45 |
| 25% Dental | 7.39 | 2.97 | 0.46 |
| Alpo Complete | 8.56 | 5.36 | 0.56 |

The results indicate that the two test products show significantly improved cleaning of the dogs' teeth over standard dry dog food.

### Example No. 5

Fifty dried pieces obtained using the inventive products of Example 4 were subjected to texture analysis as described in Example 2.

For comparison, the process is performed for each group of 50 pieces of dry products used in the dental trial (Example 4). The results are as follows:

| Product | Distance to Breakage/mm |
|---|---|
| ALPO Complete (nugget) | 2.1 |
| ALPO Complete (bone) | 1.2 |
| Example 4 (large pieces) | 6.7 |
| (density of 19.9 lbs/ft³) | |
| Example 4 (small pieces) | 2.3 |
| (density of 20.2 lbs/ft³) | |

The results indicate that the large pieces of Example 4 are significantly better than standard dried pet foods.

Because the products of Examples 1 and 4 are resistant to breakage, the animal needs to bite deeper into each piece of the product before it breaks. Therefore the animal's teeth are subjected to improved mechanical cleaning.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1-33. (canceled)

34. A dried pet food comprising a matrix comprising a protein source, carbohydrate source, insoluble fiber and the dried pet food having an unstriated appearance and comprising a length of at least 15 mm, a width of at least 13.5 mm, and a thickness of at least 12 mm, the length being greater than the thickness wherein the dried pet food has a density that ranges from about 16.8 lbs/ft³ to about 20 lbs/ft³.

35. The dried pet food of claim 34, wherein the protein source comprises denatured protein.

36. The dried pet food of claim 34, wherein the carbohydrate source comprises gelatinized carbohydrate.

37. The dried pet food of claim 34, wherein the insoluble fiber comprises approximately 2% to about 15% by weight of the matrix.

38. The dried pet food of claim 34, wherein the insoluble fiber is a cellulose fiber.

39. The dried pet food of claim 34, wherein the product does not include a humectant.

40. A dried pet food comprising a matrix comprising a protein source, a carbohydrate source, an insoluble fiber and the dried pet food having an unstriated appearance and a density that ranges from about 16.8 lbs/ft³ to about 20 lbs/ft³, wherein the dried pet food comprises a thickness of at least 12 mm and a length that is greater than the thickness.

41. The dried pet food of claim 40, wherein the protein source comprises denatured protein.

42. The dried pet food of claim 40, wherein the carbohydrate source comprises gelatinized carbohydrate.

43. The dried pet food of claim 40, wherein the insoluble fiber comprises approximately 2% to about 15% by weight of the matrix.

44. The dried pet food of claim 40, wherein the insoluble fiber is a cellulose fiber.

45. The dried pet food of claim 40, wherein the product does not include a humectant.

46. A dried pet food comprising a matrix comprising a protein source, a carbohydrate source, insoluble fiber, a density that ranges from about 16.8 lbs/ft³ to about 20 lbs/ft³ and the dried pet food comprising a length of at least 15 mm, a width of at least 13.5 mm, and a thickness of at least 12 mm, wherein the length is greater than the thickness.

47. The dried pet food of claim 46, wherein the protein source comprises denatured protein.

48. The dried pet food of claim 46, wherein the carbohydrate source comprises gelatinized carbohydrate.

49. The dried pet food of claim 46, wherein the insoluble fiber comprises approximately 2% to about 15% by weight of the matrix.

50. The dried pet food of claim 46, wherein the product does not include a humectant.

51. A dried pet food comprising at least 25% by weight of a kibble having an unstriated appearance and comprising a matrix having a protein source, carbohydrate source, insoluble fiber, and a density that ranges from about 16.8 lbs/ft³ to about 20 lbs/ft³, wherein the dried pet food comprises a thickness of at least 12 mm and a length that is greater than the thickness.

52. The dried pet food of claim 51, wherein the matrix has a length of at least 15 mm, a width of at least 13.5 mm, and a thickness of at least 12 mm.

53. A method of reducing calculus and plaque build-up on a pet's teeth comprising the steps of feeding a dried pet food to a pet; and chewing by the pet on the dried pet food having an unstriated appearance and comprising a matrix including a protein source, a carbohydrate source, insoluble fiber, and having a density that ranges from about 16.8 lbs/ft³ to about 20 lbs/ft³, wherein the dried pet food comprises a thickness of at least 12 mm and a length that is greater than the thickness.

54. A pet food comprising at least two different sized kibbles including a first sized kibble and a second sized kibble wherein the first sized kibble is larger in size than the second sized kibble, wherein the first sized kibble and the second sized kibble are present in a ratio of approximately 20 to about 80% to approximately 80 to about 20%, and at least one kibble having an unstriated appearance and a density that ranges from about 16.8 lbs/ft³ to about 20 lb/ft³.

55. The pet food of claim 54, wherein at least one of the sized kibbles has a length of at least 15 mm, a width of at least 13.5 mm, and a thickness of at least 12 mm.

56. The pet food of claim 54, wherein at least one of the sized kibbles does not include a humectant.

57. The pet food of claim 54, wherein the ratio of large to small kibbles is 20 to 50 by number percent.

58. A method for making a dry pet food comprising the steps of extruding through a non-laminar flow a protein source, carbohydrate source, and an insoluble fiber source to create a dry pet food having an unstriated appearance and having a density that ranges from about 16.8 lbs/ft³ to about 20 lbs/ft³, wherein the dry pet food comprises a thickness of at least 12 mm and a length that is greater than the thickness.

59. The method of claim 58, wherein the kibble has a length of at least 15 mm, a width of at least 13.5 mm and a thickness of at least 12 mm.

60. The method of claim 58, wherein the insoluble fiber comprises approximately 2% to about 15% by weight of the matrix.

61. A dried pet food comprising a protein source, a carbohydrate source, an insoluble fiber source and having an inner cellular structure that is created by a non laminar flow extrusion process wherein the dried pet food has a density that ranges from about 16.8 lbs/ft³ to about 20 lbs/ft³, wherein the dried pet food comprises a thickness of at least 12 mm and a length that is greater than the thickness.

62. The dried pet food of claim 61, further comprises at least one kibble that has a length of at least 15 mm, a width of at least 13.5 mm, and a thickness of at least 12 mm.

63. The dried pet food of claim 61, further comprises at least one kibble that does not include a humectant.

64. A dried pet food comprising a protein source, a carbohydrate source, an insoluble fiber source and having an inner cellular structure that is characterized by a number of microscopic air pockets wherein the dried pet food has a density that ranges from about 16.8 lbs/ft³ to about 20 lbs/ft³, wherein the dried pet food comprises a thickness of at least 12 mm and a length that is greater than the thickness.

65. The dried pet food of claim 64, wherein the interior includes circular pores.

66. The dried pet food of claim 64, wherein the interior has a sponge-like structure.
